(19) United States
(12) Patent Application Publication
(10) Pub. No.: US 2025/0285341 A1
(43) Pub. Date: Sep. 11, 2025

(54) LEARNING APPARATUS, METHOD AND PROGRAM

(71) Applicant: NIPPON TELEGRAPH AND TELEPHONE CORPORATION, Tokyo (JP)

(72) Inventors: Daisuke NIIZUMI, Tokyo (JP); Kunio KASHINO, Tokyo (JP); Yasunori OHISHI, Tokyo (JP); Daiki TAKEUCHI, Tokyo (JP); Noboru HARADA, Tokyo (JP)

(73) Assignee: NIPPON TELEGRAPH AND TELEPHONE CORPORATION, Tokyo (JP)

(21) Appl. No.: 18/858,459

(22) PCT Filed: Apr. 25, 2022
(86) PCT No.: PCT/JP2022/018703

§ 371 Date: Oct. 21, 2024

(51) Int. Cl. G06T 11/20; G10L 21/12; G10L 25/18

(52) U.S. Cl. CPC G06T 11/206; G10L 21/12; G10L 25/18

(57) ABSTRACT

A learning device includes: spectrogram generation circuitry 1 that generates a spectrogram from an input sound signal; patch generation circuitry 2 that divides the generated spectrogram to generate a plurality of patches; a mask processing circuitry 3 that selects some patches as masked patches; reconstruction circuitry 4 that obtains a plurality of reconstructed patches by reconstructing the plurality of patches by processing of an encoder and a decoder in a transformer serving as a deep learning model by using visible patches other than the masked patches among the plurality of patches and mask tokens corresponding to the masked patches; and parameter update circuitry 5 that updates a parameter of the encoder and a parameter of the decoder such that the masked patches approach reconstructed patches corresponding to the masked patches. The number of layers of the decoder is three or more.

### TECHNICAL FIELD

The present invention relates to a deep learning technique.

### BACKGROUND ART

In fields other than sounds in particular, there are frameworks for expression learning called Masked Language Modeling (MLM) and Masked Image Modeling (MIM). Those frameworks mask part of an input and use information obtained from a non-masked portion to restore and predict the masked portion. The frameworks aim to obtain a good information extraction model (also referred to as an encoder, and also abstractly referred to as an “expression”) by performing learning so as to extract effective information from the non-masked portion.

Regarding sound signals, Non Patent Literature 1 proposes learning in which mask restoration and classification are combined with respect to a spectrogram.

### CITATION LIST

### Non Patent Literature

Non Patent Literature 1: Yuan Gong, Cheng-I Jeff Lai, Yu-An Chung, James Glass, “SSAST: Self-Supervised Audio Spectrogram Transformer”, MIT Computer Science and Artificial Intelligence Laboratory, Cambridge, MA 02139

### SUMMARY OF INVENTION

### Technical Problem

In a feature value extracted by using the information extraction model generated by the method disclosed in Non Patent Literature 1, high performance may not be necessarily obtained in a downstream task.

An object of the present invention is to provide a learning device, method, and program capable of generating a model having higher performance than before.

### Solution to Problem

A learning device according to an aspect of the present invention includes: a spectrogram generation unit that generates a spectrogram from an input sound signal; a patch generation unit that divides the generated spectrogram to generate a plurality of patches; a mask processing unit that selects some patches from among the plurality of patches as masked patches; a reconstruction unit that obtains a plurality of reconstructed patches by reconstructing the plurality of patches by processing of an encoder and a decoder in a transformer serving as a deep learning model by using visible patches other than the masked patches among the plurality of patches and mask tokens corresponding to the masked patches; and a parameter update unit that updates a parameter of the encoder and a parameter of the decoder such that the masked patches approach reconstructed patches corresponding to the masked patches among the plurality of reconstructed patches, in which the number of layers of the decoder is three or more.

### ADVANTAGEOUS EFFECTS OF INVENTION

Performance of a model generated by a learning device can be higher than before by setting the number of layers of a decoder to three or more.

### BRIEF DESCRIPTION OF DRAWINGS

FIG. 1 shows an example of a functional configuration of a learning device.

FIG. 2 shows an example of a processing procedure of a learning method.

FIG. 3 shows an overview of a processing example of a learning device and method.

FIG. 4 shows an experimental result.

FIG. 5 shows an experimental result.

FIG. 6 shows an experimental result.

FIG. 7 shows an experimental result.

FIG. 8 shows an experimental result.

FIG. 9 shows an example of a functional configuration of a computer.

### DESCRIPTION OF EMBODIMENTS

Hereinafter, embodiments of the present invention will be described in detail. In the drawings, components having the same functions are denoted by the same reference numerals, and redundant description will be omitted.

### Learning Device and Method

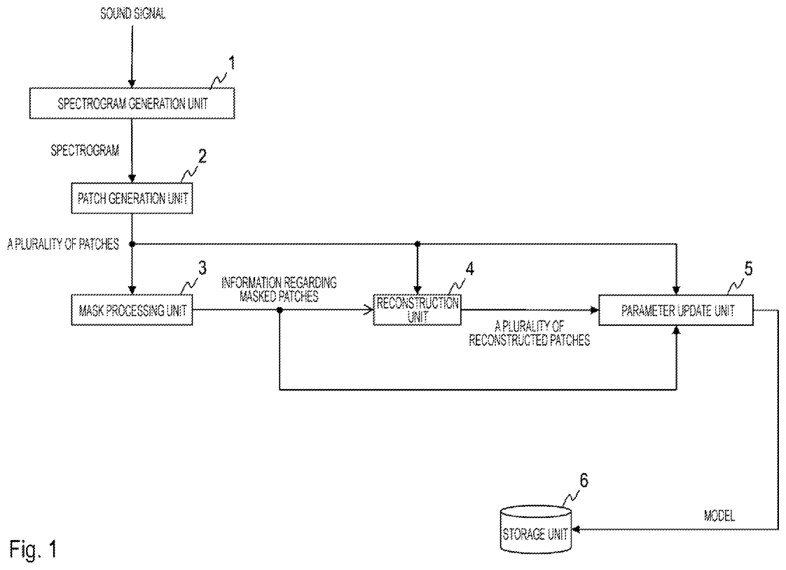

As shown in FIG. 1, a learning device includes, for example, a spectrogram generation unit 1, a patch generation unit 2, a mask processing unit 3, a reconstruction unit 4, a parameter update unit 5, and a storage unit 6.

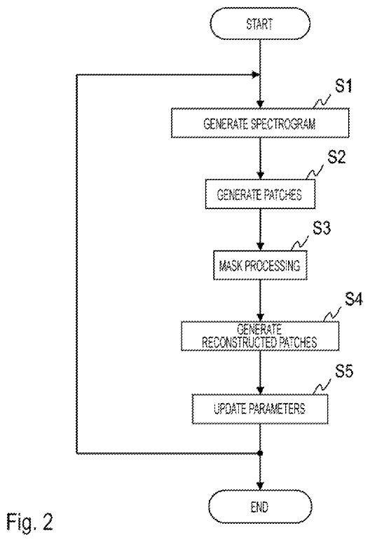

A learning method is implemented by, for example, each component of the learning device performing processing in step S1 to step S5 shown in FIG. 2.

Spectrogram Generation Unit 1 A sound signal such as an acoustic signal or audio signal is input to the spectrogram generation unit 1.

The spectrogram generation unit 1 generates a spectrogram from the input sound signal (step S1).

The generated spectrogram is output to the patch generation unit 2.

For example, when the number of spectrograms bin is denoted by B and the number of frames of the sound signal is denoted by F, the spectrogram having a size of B×F is generated. The symbols B and F are predetermined positive integers. For example, B=80 and F=304 are satisfied. A time length of one frame is 10 ms.

### Patch Generation Unit 2

The spectrogram generated by the spectrogram generation unit 1 is input to the patch generation unit 2.

The patch generation unit 2 divides the spectrogram to generate a plurality of patches (step S2).

The plurality of generated patches is output to the mask processing unit 3, the reconstruction unit 4, and the parameter update unit 5.

For example, the patch generation unit 2 divides the spectrogram having the size of B×F into a size of b×f. The symbols b and f are predetermined positive integers. The symbol b may be a divisor of B, and the symbol f may be a divisor of F. For example, when B=80 and F=304 are satisfied, and b=16 and f=16 are satisfied, (80/16)×(304/16)=5×19=95 patches having a size of 16×16 are generated from the spectrogram having the size of 80×304.

As described above, the patch generation unit 2 divides the spectrogram into grids, for example.

### Mask Processing Unit 3

The plurality of patches generated by the patch generation unit 2 is input to the mask processing unit 3.

The mask processing unit 3 selects some patches from among the plurality of patches as masked patches (step S3).

Information regarding the patches selected as the masked patches is output to the reconstruction unit 4 and the parameter update unit 5.

The mask processing unit 3 selects, for example, X % of the plurality of patches as the masked patches. The symbol X denotes a real number from 0 to 100. The symbol X is, for example, 75. The mask processing unit 3 may select 50% or more of the plurality of patches as the masked patches.

The mask processing unit 3 may randomly select patches or may select patches according to a predetermined pattern.

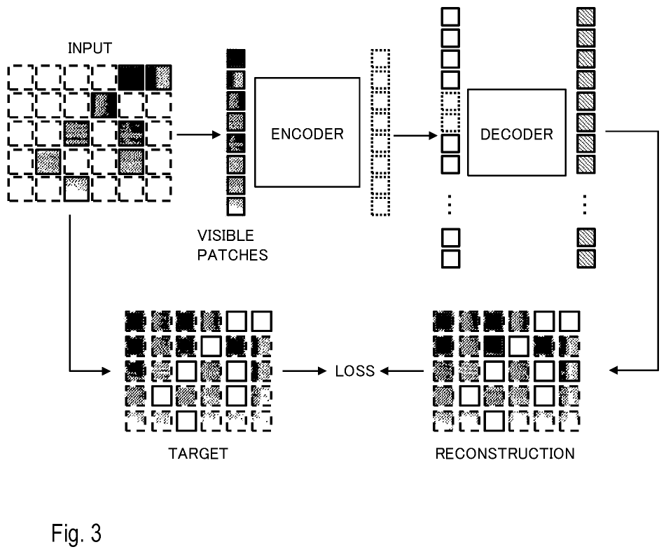

FIG. 3 shows an overview of a processing example of the learning device and method. As shown in INPUT in the example of FIG. 3, the spectrogram is divided into 5×6 patches. As shown in INPUT in the example of FIG. 3, patches indicated by broken lines are selected as the masked patches.

### Reconstruction Unit 4

The information regarding the masked patches selected by the mask processing unit 3 is input to the reconstruction unit 4. The plurality of patches generated by the patch generation unit 2 is also input to the reconstruction unit 4.

The reconstruction unit 4 obtains a plurality of reconstructed patches by reconstructing the plurality of patches by processing of an encoder and a decoder in a transformer serving as a deep learning model by using visible patches other than the masked patches among the plurality of patches and mask tokens corresponding to the masked patches (step S4).

The mask token is a vector. Each element of the mask token has, for example, a random real number as an initial value. As described later, the mask token may be updated by the parameter update unit 5. In this case, the reconstruction unit 4 uses the updated mask token.

The plurality of obtained reconstructed patches is output to the parameter update unit 5.

The decoder has a sufficiently deep layer. For example, the number of layers of the decoder is three or more. The decoder may include the transformer or a network having performance similar to that of the transformer and may have three or more layers. This makes it possible to generate a model having higher performance than before. This is because, in the technique of Non Patent Literature 1, a portion corresponding to the decoder in the transformer has a relatively shallow layer.

When the decoder has a sufficiently deep layer, it is considered that a restoration function is mainly learned by the decoder, and an expression that is not specialized for restoration is learned by the encoder. Therefore, it is considered that a possibility of obtaining high performance in a downstream task increases based on a feature value extracted by using the encoder learned as described above.

Examples of the downstream task include noise removal, super-resolution, style transfer, translation between modalities, audio source separation, voice conversion, and anomaly detection.

Hereinafter, examples 1 and 2 of the processing of the reconstruction unit 4 will be described.

### Example 1

An encoder processing unit 41 of the reconstruction unit 4 inputs the visible patches to the encoder in the transformer serving as the deep learning model to obtain an encoding result.

A decoder processing unit 42 of the reconstruction unit 4 inputs the encoding result and the mask tokens to the decoder to obtain a decoding result. As the decoding result, a plurality of reconstructed patches generated by reconstructing the plurality of patches is obtained.

In the example of FIG. 3, the visible patches indicated by the broken lines in INPUT other than the masked patches are input to the encoder, and an encoding result indicated by dotted lines is obtained. In the example of FIG. 3, a result obtained by adding the mask tokens corresponding to the masked patches to the encoding result is input to the decoder, and a decoding result indicated by a right-downward diagonal stripe pattern is obtained.

### Example 2

The encoder processing unit 41 of the reconstruction unit 4 inputs the visible patches and the mask tokens to the encoder in the transformer serving as the deep learning model to obtain an encoding result.

The decoder processing unit 42 of the reconstruction unit 4 inputs the encoding result to the decoder to obtain a decoding result. As the decoding result, a plurality of reconstructed patches generated by reconstructing the plurality of patches is obtained.

Parameter Update Unit 5 The plurality of reconstructed patches obtained by the reconstruction unit 4 is input to the parameter update unit 5. The information regarding the masked patches selected by the mask processing unit 3 and the plurality of patches generated by the patch generation unit 2 are also input to the parameter update unit 5.

The parameter update unit 5 updates a parameter of the encoder and a parameter of the decoder such that the masked patches approach reconstructed patches corresponding to the masked patches among the plurality of reconstructed patches (step S5). Note that the parameter update unit 5 may update mask tokens.

For example, the parameter update unit 5 updates the parameter of the encoder and the parameter of the decoder by a method such as backpropagation so as to reduce a magnitude of an error between the masked patches and the reconstructed patches corresponding to the masked patches among the plurality of reconstructed patches.

In the example of FIG. 3, the parameters are updated to reduce the magnitude of the error between the masked patches indicated by broken lines in TARGET and the reconstructed patches corresponding to the masked patches indicated by broken lines in RECONSTRUCTION.

### Repetitive Processing

The processing in step S1 to step S5 is repeatedly performed. For example, the processing in steps S1 to S5 is performed on each of a plurality of different sound signals.

For example, the processing in steps S1 to S5 is repeatedly performed until the parameter of the encoder and the parameter of the decoder converge.

### Storage Unit 6

When the repetition is completed, a model serving as the encoder and the decoder determined based on the latest parameters updated by the parameter update unit 5 is stored in the storage unit 6.

### Experimental Results

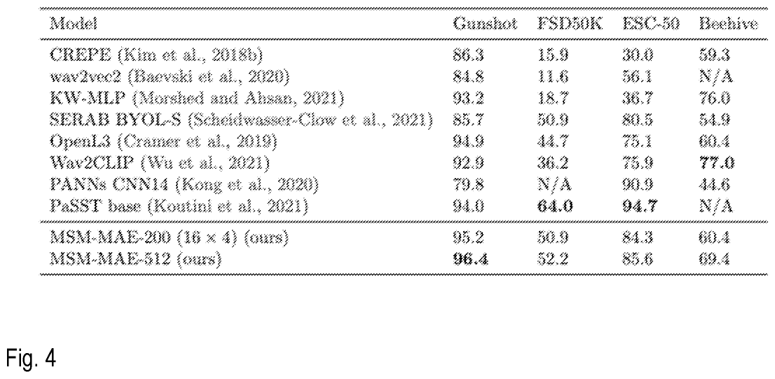

FIGS. 4 to 6 show experimental results obtained in a case where the encoder learned by the above learning device and method (processing of the reconstruction unit 4 is the example 1) is used as a feature value extractor and is applied to various downstream tasks.

In FIG. 4, Gunshot denotes a task of classifying positions of sounds of gunshots, FSD50K denotes a task of classifying a plurality of labeled acoustic events, ESC-50 denotes a task of classifying environmental sounds, and Beehive denotes a task of identifying presence or absence of a queen bee from a sound of a honeycomb.

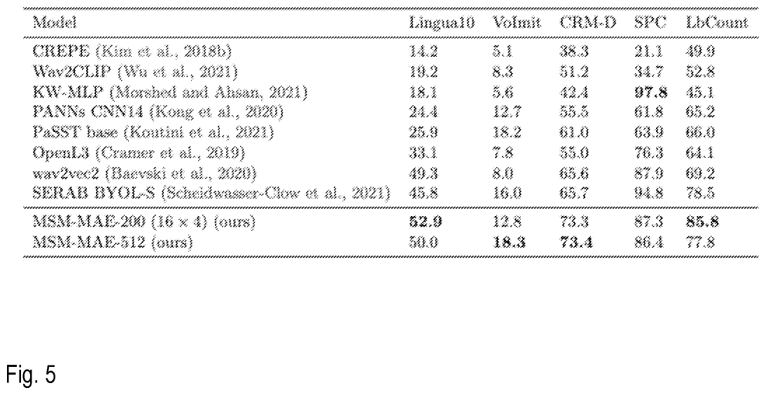

In FIG. 5, Lingua10 denotes a task of specifying (classifying) a language of voice, VoImit denotes a task of estimating (classifying) an original sound by receiving voice simulating a desired sound as an input, CRM-D denotes a task of recognizing (classifying) an emotion included in voice, SPC denotes a task of identifying (classifying) a voice command word, and LbCount denotes a task of estimating the number of speakers.

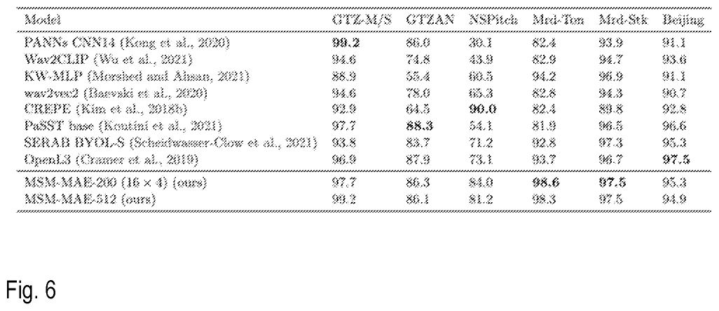

In FIG. 6, GTZ-M/S denotes a task of performing binary classification on music or voice, GTZAN denotes a task of classifying music genres, NSPitch denotes a task of classifying pitches of musical sounds, Mrd-Ton denotes a task of classifying timbres of percussion sounds, Mrd-Stk denotes a task of classifying how percussion sounds are made, and Beijing denotes a task of classifying musical sounds of Chinese percussion instruments.

It can be seen that performance is improved in the tasks of Gunshot, Lingua10, VoImit, CRM-D, LbCount, Mrd-Tom, and Mrd-Stk as compared with the past method.

### Modification Example of Learning Device and Method

The time length of the spectrogram may be longer than a predetermined time length. In other words, the number of frames of a sound signal input to the spectrogram generation unit 1 may be larger than the predetermined number of frames.

For example, the time length of the spectrogram may be equal to or more than four seconds. By increasing the time length of the spectrogram, performance of the model generated by the learning device and method is improved.

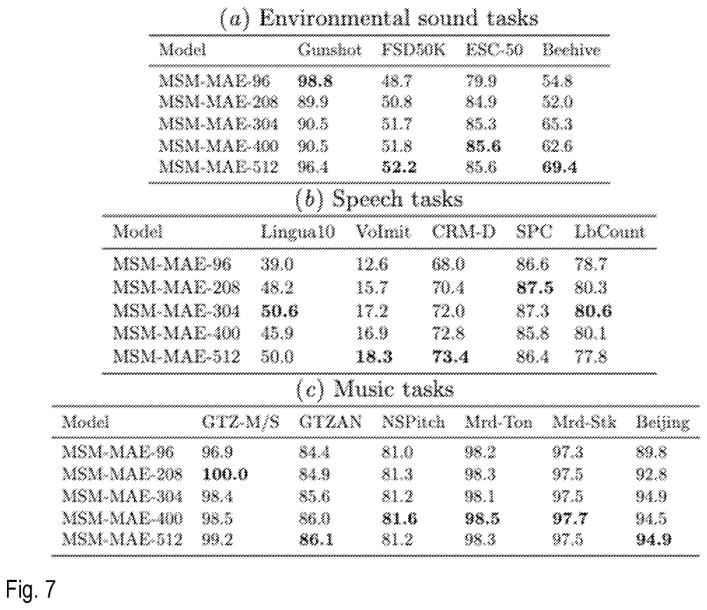

FIG. 7 shows experimental results obtained in a case where the time length of the spectrogram is set to a plurality of different time lengths. In FIG. 7, numbers following “MSM-MAE-” indicate the number of frames of the sound signal input to the spectrogram generation unit 1. For example, “MSM-MAE-96” indicates that the number of frames of the sound signal input to the spectrogram generation unit 1 is 96.

As can be seen from FIG. 7, the performance of the model generated by the learning device and method is improved as the time length of the spectrogram increases.

The size of the patch may be smaller than a predetermined size. For example, the size of the patch may be smaller than the size of 16×8, and the size of the patch may be smaller than the size of 16×4. Because a resolution is increased by reducing the size of the patch, the performance of the model generated by the learning device and method is further improved.

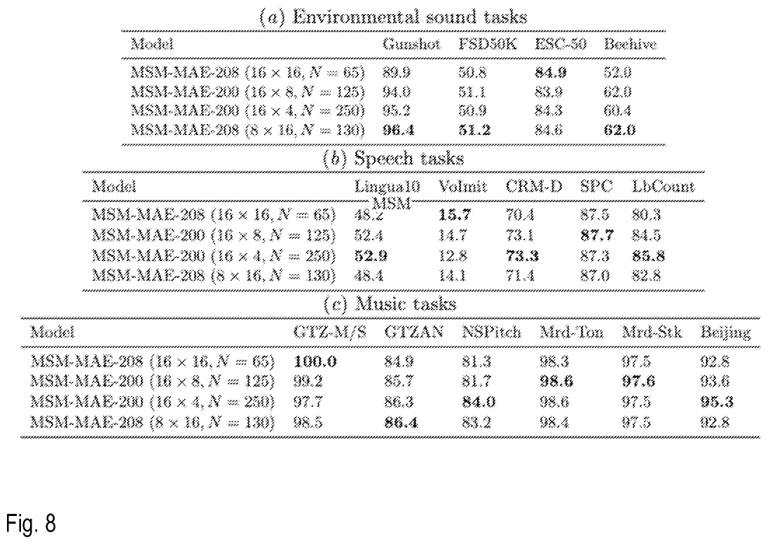

FIG. 8 shows experimental results obtained in a case where the size of the patch is set to a plurality of different sizes. In FIG. 8, numbers on the left in parentheses following “MSM-MAE-200” and “MSM-MAE-208” indicate the size of the patch, and numbers on the right therein indicates the total number of patches. For example, “MSM-MAE-208 (16×16, N=65)” indicates that the size of the patch is 16×16, and the total number N of patches is 65.

As can be seen from FIG. 8, the performance of the model generated by the learning device and method is improved as the size of the patch is decreased.

### Modification Example

While the embodiment of the present invention has been described above, specific configurations are not limited to the embodiment, and it is needless to say that appropriate design changes and the like are included in the present invention without departing from the gist of the present invention.

The various types of processing described in the embodiment may be performed not only in chronological order in accordance with the described order, but also in parallel or individually depending on the processing capability of a device that performs the processing or as necessary.

For example, data exchange between the components of the learning device and data exchange between the components of the transform device may be performed directly or via a storage unit (not illustrated).

### Program and Recording Medium

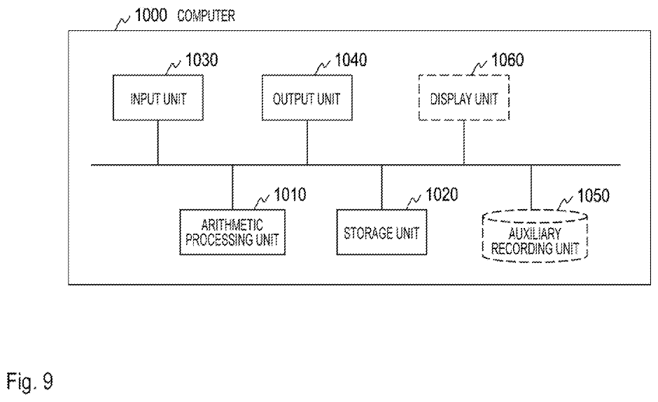

Processing of each unit of each device described above may be implemented by a computer, and, in this case, processing content of a function that each device should have is written by a program. By causing a storage unit 1020 of a computer 1000 in FIG. 9 to read the program and causing an arithmetic processing unit 1010, an input unit 1030, an output unit 1040, a display unit 1060, and the like to operate, various processing functions in each device described above are implemented on the computer.

The program in which the processing content is written can be recorded on a computer-readable recording medium. The computer-readable recording medium is, for example, a non-transitory recording medium and is specifically a magnetic recording device, an optical disc, or the like.

The program is distributed by, for example, selling, transferring, or renting a portable recording medium such as a DVD or a CD-ROM on which the program is recorded. Further, the program may be stored in a storage device of a server computer, and the program may be distributed by being transferred from the server computer to another computer via a network.

For example, the computer that executes the program first temporarily stores the program recorded in the portable recording medium or the program transferred from the server computer in an auxiliary recording unit 1050 serving as a non-transitory storage device of the computer. Then, at the time of performing processing, the computer reads the program stored in the auxiliary recording unit 1050 serving as the non-transitory storage device of the computer into the storage unit 1020 and performs processing according to the read program. As another embodiment of the program, the computer may directly read the program from the portable recording medium into the storage unit 1020 and perform processing according to the program, or, each time the program is transferred from the server computer to the computer, the computer may sequentially perform processing according to the received program.

Further, the above processing may be performed by a so-called ASP (application service provider) service that implements a processing function only by issuing an instruction to execute the program and acquiring a result thereof, without transferring the program from the server computer to the computer. The program in the present embodiment includes information that is used for processing by an electronic computer and is equivalent to the program (e.g. data that is not a direct command to the computer but has a property that defines processing performed by the computer).

In the present embodiment, the present device is configured by executing a predetermined program on the computer. However, at least part of the processing content may be implemented by hardware. For example, the spectrogram generation unit 1, the patch generation unit 2, the mask processing unit 3, the reconstruction unit 4, and the parameter update unit 5 may be configured by a processing circuit.

In addition, it is needless to say that modifications can be appropriately made without departing from the gist of the present invention.

1. A learning device comprising:
spectrogram generation circuitry that generates a spectrogram from an input sound signal;
patch generation circuitry that divides the generated spectrogram to generate a plurality of patches;
mask processing circuitry that selects some patches from among the plurality of patches as masked patches;
reconstruction circuitry that obtains a plurality of reconstructed patches by reconstructing the plurality of patches by processing of an encoder and a decoder in a transformer serving as a deep learning model by using visible patches other than the masked patches among the plurality of patches and mask tokens corresponding to the masked patches; and
parameter update circuitry that updates a parameter of the encoder and a parameter of the decoder such that the masked patches approach reconstructed patches corresponding to the masked patches among the plurality of reconstructed patches, wherein
the number of layers of the decoder is three or more.

2. The learning device according to claim 1, wherein the reconstruction circuitry includes (1) encoder processing circuitry that inputs the visible patches to the encoder to obtain an encoding result, and (2) decoder processing circuitry that inputs the encoding result and the mask tokens to the decoder to obtain, as a decoding result, the plurality of reconstructed patches generated by reconstructing the plurality of patches.

3. The learning device according to claim 1, wherein the spectrogram has a time length longer than a predetermined time length.

4. The learning device according to claim 1, wherein the patch has a size smaller than a predetermined size.

5. A learning method comprising:
a spectrogram generation step of causing spectrogram generation circuitry to generate a spectrogram from an input sound signal;
a patch generation step of causing patch generation circuitry to divide the generated spectrogram to generate a plurality of patches;
a mask processing step of causing mask processing circuitry to select some patches from among the plurality of patches as masked patches;
a reconstruction step of causing reconstruction circuitry to obtain a plurality of reconstructed patches by reconstructing the plurality of patches by processing of an encoder and a decoder in a transformer serving as a deep learning model by using visible patches other than the masked patches among the plurality of patches and mask tokens corresponding to the masked patches; and
a parameter update step of causing parameter update circuitry to update a parameter of the encoder and a parameter of the decoder such that the masked patches approach reconstructed patches corresponding to the masked patches among the plurality of reconstructed patches, wherein
the number of layers of the decoder is three or more.

6. A non-transitory computer readable medium that stores a program for causing a computer to perform each step of the learning method according to claim 5.
